(19) United States
(12) Patent Application Publication
(10) Pub. No.: US 2011/0069392 A1
(43) Pub. Date: Mar. 24, 2011

(54) LIGHT DIFFUSING SILICONE RUBBER COMPOSITION AND MOLDED PART

(75) Inventors: Toshio Yamazaki, Annaka-shi (JP); Masayuki Yoshida, Annaka-shi (JP)

(73) Assignee: Shin-Etsu Chemical Co., Ltd., Chiyoda-ku (JP)

(21) Appl. No.: 12/874,810

(22) Filed: Sep. 2, 2010

(30) Foreign Application Priority Data
Sep. 24, 2009 (JP) 2009-219327

(51) Int. Cl. G02B 5/02; C08L 83/00

(52) U.S. Cl. 359/599; 525/100; 525/106

(57) ABSTRACT

A light diffusing silicone rubber composition is provided comprising a silicone rubber compound having an overall transmittance of at least 70% when measured in a cured sheet of 2 mm thick, and a light diffusing agent added and dispersed in the silicone rubber compound. The light diffusing agent is in the form of poly(meth)acrylate resin, polystyrene resin or (meth)acrylate-styrene copolymer microparticulates having an average particle size of 0.3-100 μm.

### CROSS-REFERENCE TO RELATED APPLICATION

This non-provisional application claims priority under 35 U.S.C. §119(a) on Patent Application No. 2009-219327 filed in Japan on Sep. 24, 2009, the entire contents of which are hereby incorporated by reference.

### TECHNICAL FIELD

This invention relates to light diffusing silicone rubber compositions suitable for forming members for diffusing or scattering light, such as luminaire covers, illumination displays, and backlight diffusers, lightguides and transmissive screens in liquid crystal displays, and molded parts of the compositions.

### BACKGROUND ART

Light diffusing resin compositions are known in the art as comprising highly transparent thermoplastic binder resins such as (meth)acrylic resins, polycarbonate resins, polyester resins or polyurethane resins and inorganic fine particles of calcium carbonate, barium sulfate, aluminum hydroxide, titanium dioxide or glass which are added to and dispersed in the resin. Cured products of these compositions suffer from a substantial drop of overall light transmittance. This problem may be solved by a light diffusing agent which provides full light diffusion without detracting from overall light transmittance. Typical light diffusing agents include powdered organic resins such as crosslinked polymethyl methacrylate, crosslinked polystyrene, crosslinked methyl methacrylate-styrene copolymers, and silicone resins as disclosed in JP-A 2005-247999, JP-A 2005-298710, JP-A 2005-320380, JP-A 2006-37008, JP-A 2006-84927, and JP-A 2009-103892.

### CITATION LIST

Patent Document 1: JP-A 2005-247999
Patent Document 2: JP-A 2005-298710
Patent Document 3: JP-A 2005-320380
Patent Document 4: JP-A 2006-37008
Patent Document 5: JP-A 2006-84927
Patent Document 6: JP-A 2009-103892

### SUMMARY OF INVENTION

Prior art light diffusing resin compositions use rigid thermoplastic resins as the binder resin. When molded parts of such rigid resin compositions are applied to luminaires and displays, there is a risk that breakage by accidental impacts might be hazardous to the human body. Also undesirably the thermoplastic resins used as the binder resin in the prior art light diffusing resin compositions have a narrow service temperature range because they lack low-temperature performance and heat resistance.

An object of the invention is to provide a light diffusing silicone rubber composition which meets both the requirements of overall light transmittance and light diffusion, has improved impact resistance, low-temperature performance, and heat resistance, and offers a wide service temperature range.

The inventors have found that a light diffusing silicone rubber composition is obtainable by adding a microparticulate polymeric resin selected from poly(meth)acrylate resins, polystyrene resins, and (meth)acrylate-styrene copolymers as a light diffusing agent to a transparent silicone rubber compound, and dispersing the agent in the compound.

In one aspect, the invention provides a light diffusing silicone rubber composition comprising 100 parts by weight of a silicone rubber compound having an overall transmittance of at least 70% when measured in a cured sheet of 2 mm thick, and 0.01 to 10 parts by weight a light diffusing agent added and dispersed in the silicone rubber compound. The light diffusing agent is of at least one polymeric resin selected from the group consisting of poly(meth)acrylate resins, polystyrene resins, and (meth)acrylate-styrene copolymers, in microparticulate form having an average particle size of 0.3 to 100 μm.

In a preferred embodiment, the light diffusing agent has a refractive index of at least 1.48 with respect to sodium D line at 25° C. In another preferred embodiment, the light diffusing agent is of a crosslinked polymeric resin in microparticulate form. In a further preferred embodiment, the light diffusing agent is in the form of spherical microparticulates.

The silicone rubber composition may further comprise an addition curing agent or organic peroxide curing agent.

In another aspect, the invention provides a molded light diffusing silicone rubber comprising the light diffusing silicone rubber composition in the cured state, the silicone rubber having an overall transmittance of at least 50%, a diffused light transmittance of at least 45%, and a haze of at least 90, when measured in a cured sheet of 2 mm thick.

### ADVANTAGEOUS EFFECTS OF INVENTION

According to the invention, an amount of a light diffusing agent consisting of polymeric resin microparticulates having an average particle size of 0.3 to 100 μm is added to and dispersed in a silicone rubber compound which cures into a transparent or semitransparent product, to formulate a light diffusing silicone rubber composition. The light diffusing silicone rubber composition cures into a product which meets both the requirements of overall light transmittance and light diffusion. The molded rubber product (cured product) is light diffusive, elastic like ordinary silicone rubber, and serviceable over a wide temperature range.

### DESCRIPTION OF EMBODIMENTS

The light diffusing silicone rubber composition is defined as comprising a silicone rubber compound and a light diffusing agent added and dispersed therein. The silicone rubber compound is a base of the composition prior to blending and dispersion of the light diffusing agent, that is, provides a matrix for receiving the light diffusing agent dispersed therein. The silicone rubber compound should have relatively high transparency, specifically an overall light transmittance of at least 70% when measured in a cured sheet of 2 mm thick.

Typically the silicone rubber compound comprises a curable organopolysiloxane as a base polymer and a reinforcing or non-reinforcing inorganic filler such as silica fine powder. The inorganic filler is generally used in an amount of 0 to 200 parts, preferably 0.1 to 100 parts, more preferably 0.5 to 50 parts by weight relative to 100 parts by weight of the curable organopolysiloxane. A curing agent and other necessary components may be blended in the silicone rubber compound to formulate a silicone rubber composition.

The curing agent used herein may be any of well-known curing agents depending on the type of a curable organopolysiloxane. The curing mechanism may be selected from the heat curing, room temperature curing, and UV curing mechanisms, and combinations thereof, and the crosslinking mode may be selected from the addition (or hydrosilylation) crosslinking, condensation crosslinking, and organic peroxide crosslinking modes. Among others, the heat curing mechanism through addition (or hydrosilylation) crosslinking is preferred because the molding time is short and molded or cured parts undergo little changes with time of transparency (yellowing or clouding).

As mentioned above, the silicone rubber compound used herein forms a transparent or semitransparent cured product having an overall transmittance of at least 70% when measured in a cured sheet of 2 mm thick. Specifically, the overall transmittance is given by providing a curable organopolysiloxane, adding thereto a curing agent which is selected for the crosslinking mode of the organopolysiloxane, curing the organopolysiloxane into a sheet of 2 mm thick, and measuring the transmission of light through the sheet. In an embodiment that utilizes the addition (or hydrosilylation) crosslinking mode, the type and amount of the curing agent and the base polymer are as described below.

### Base Polymer:

Alkenyl-containing organopolysiloxane

### Curing Agent:

Organohydrogenpolysiloxane (crosslinker) in such an amount as to provide 0.5 to 5 moles, preferably 0.8 to 3 moles of SiH groups per mole of alkenyl groups in the alkenyl-containing organopolysiloxane
Platinum compound (curing catalyst) in such an amount as to provide 0.1 to 1,000 ppm, preferably 0.5 to 500 ppm of platinum metal based on the weight of the alkenyl-containing organopolysiloxane

### Curing Conditions:

press molding or hot atmospheric vulcanization (HAV) at 120° C. for 10 minutes

In an embodiment that utilizes the organic peroxide crosslinking mode, the type and amount of the curing agent and the base polymer are as described below.

### Base Polymer:

Alkenyl-containing organopolysiloxane

### Curing Agent:

Organic peroxide in an amount of 0.1 to 10 parts, preferably 0.5 to 5 parts by weight relative to 100 parts by weight of the alkenyl-containing organopolysiloxane

### Curing Conditions:

press molding or hot atmospheric vulcanization (HAV) at 120° C. for 10 minutes

It is noted that the overall transmittance is measured using a direct reading haze computer system HGM-2 (Suga Test Instruments Co., Ltd.) under conditions of C light source, visual field 2°, and light flux diameter 13 mm.

The silicone rubber compound, which is a base prior to blending and dispersion of the light diffusing agent, that is, provides a matrix for receiving the light diffusing agent dispersed therein, is typically a silicone rubber base compound of the millable type (non-self-flowing at room temperature) which comprises an alkenyl-containing diorganopolysiloxane (base polymer) which is gum-like or liquid at room temperature (25° C.), a reinforcing or non-reinforcing inorganic filler such as silica fine powder, and optionally, a dispersant (or wetter), a reinforcing silicone resin, and the like wherein the components are uniformly milled at room temperature or elevated temperature. When it is desired to cure or crosslink the silicone rubber base compound, an effective amount of an addition (hydrosilylation) curing agent which is a combination of an organohydrogenpolysiloxane (crosslinker) and a platinum group metal compound (hydrosilylation catalyst) or a peroxide curing agent comprising an organic peroxide (vulcanizing agent) is added thereto to formulate a silicone rubber composition, which is heat cured or crosslinked into a cured product or silicone rubber. The amount of the curing agent added is as described above.

Exemplary of the composition which is liquid at room temperature (25° C.), especially the liquid silicone rubber composition of the addition curing type is a composition comprising in intimate admixture, the components of the base compound mentioned above, an addition (hydrosilylation) curing agent which is a combination of an organohydrogenpolysiloxane (crosslinker) and a platinum group metal compound (hydrosilylation catalyst), and optionally an addition reaction regulator.

The silicone rubber compound and the silicone rubber composition are not particularly limited as long as the above-mentioned conditions are met. Any of commercially available silicone rubber compounds and compositions may be used as purchased. Specifically, silicone rubber compounds and compositions of the millable type, and liquid silicone rubber compositions are commercially available. Examples include silicone rubber compounds of the millable type: KE-571-U, KE-1571-U, KE-951-U, KE-541-U, KE-551-U, KE-561-U, KE-961T-U, KE-1541-U, KE-1551-U, KE-941-U and KE-971T-U; liquid silicone rubber compositions of the addition curing type: KE-1950-40A/B, KE-1950-50A/B, KE-1950-60A/B, KE-1950-70A/B, KEG-2000-40A/B, KEG-2000-50A/B, KEG-2000-60A/B, and KEG-2000-70A/B; and highly transparent liquid silicone rubber compositions of the addition curing type: KE-1935A/B and X-34-1931A/B, all commercially available from Shin-Etsu Chemical Co., Ltd.

A light diffusing agent is included in the light diffusing silicone rubber composition. The light diffusing agent consists of at least one polymeric resin selected from among poly(meth)acrylate resins, polystyrene resins, and (meth)acrylate-styrene copolymers in microparticulate form.

In general, light diffusing resin compositions are believed to have a higher light diffusion efficiency as the difference in refractive index between the binder resin and the microparticulate light diffusing agent becomes greater. With respect to the refractive index relative to sodium D line at 25° C., poly(meth)acrylate resins have a value of 1.49, polystyrene resins have a value of 1.59, and (meth)acrylate-styrene copolymers have a value of 1.50 to 1.55 whereas silicone rubbers before and after curing (uncured and cured compositions) have values of 1.40 to 1.45. Then a choice of a combination giving a greater difference of refractive index provides a light diffusing silicone rubber composition with a high light diffusion efficiency. In this regard, polystyrene resins are most preferred as the microparticulate light diffusing agent.

The at least one microparticulate polymeric resin selected from among poly(meth)acrylate resins, polystyrene resins, and (meth)acrylate-styrene copolymers is desirably a crosslinked polymeric resin in microparticulate form resulting from copolymerization of crosslinkable monomers. The crosslinked polymeric resin has heat resistance so that it may not melt even at high temperature, and preferably has a melting temperature of at least 200° C., more preferably at least 250° C. This is because it is necessary to take into account silicone rubber compositions of the heat curing type which require a temperature of about 100 to 180° C. for crosslinking or curing and because in such applications as luminaires, the molded product can be exposed to the heat of a heat generating component. If a microparticulate resin light diffusing agent which is less heat resistant is applied to the light diffusing silicone rubber composition, the light diffusing agent can be melted upon heat curing of the silicone rubber composition or upon exposure of the molded or cured product to high temperature. This results in a failure to provide the desired overall transmittance and light diffusion.

The at least one polymeric resin selected from among poly(meth)acrylate resins, polystyrene resins, and (meth)acrylate-styrene copolymers is in the form of microparticulates and desirably spherical microparticulates. Irregular microparticulates obtained by grinding a polymeric resin lead to a lowering of light diffusion efficiency because transmission of light through particulates and reflection of light at particulate surfaces are very irregular. In contrast, spherical microparticulates are expected to have a high light diffusion efficiency because transmission of light through particulates and reflection of light at particulate surfaces are of high regularity. The polymeric resin in spherical microparticulate form may be prepared by emulsion polymerization or dispersion polymerization.

The resin microparticulates as the light diffusing agent should have an average particle size of 0.3 to 100 μm, preferably 1 to 10 μm, and more preferably 3 to 5 μm. Resin microparticulates with an average particle size of less than 0.3 μm provide a low light diffusion efficiency whereas resin microparticulates with an average particle size in excess of 100 μm lead to a lowering of overall transmittance. As used herein, the “average particle size” refers to a cumulative weight average value D₅₀ or median diameter in particle size distribution measurement by the laser diffraction method.

The resin microparticulates as the light diffusing agent are commercially available. Examples include spherical microparticulates of crosslinked polymethyl methacrylate MBX series, spherical microparticulates of crosslinked polystyrene SBX series, spherical microparticulates of crosslinked styrene-methyl methacrylate copolymer MSX series, all available from Sekisui Plastics Co., Ltd.; and spherical microparticulates of crosslinked acrylic resin Ganz Pearl GM series and spherical microparticulates of crosslinked acrylic-styrene copolymer Ganz Pearl GSM series, all available from Ganz Chemical Co., Ltd.

The resin microparticulates as the light diffusing agent are added and dispersed in an amount of 0.01 to 10 parts, preferably 0.1 to 5 parts, and more preferably 0.5 to 2 parts by weight relative to 100 parts by weight of the silicone rubber compound. Less than 0.01 pbw of the light diffusing agent fails to provide a satisfactory light diffusion efficiency whereas more than 10 pbw of the light diffusing agent can detract from the physical properties of silicone rubber.

While several embodiments of the light diffusing silicone rubber composition have been described, a molded or cured product of the composition should preferably have optical properties as measured in a cured sheet of 2 mm thick, including an overall transmittance of at least 50%, a diffused light transmittance of at least 45%, and a haze of at least 90. More preferably the cured product has an overall transmittance of at least 60%, a diffused light transmittance of at least 55%, and a haze of at least 92.

It is noted that the overall transmittance is measured using a direct reading haze computer system HGM-2 (Suga Test Instruments Co., Ltd.) under conditions of C light source, visual field 2°, and light flux diameter 13 mm. When an overall transmittance is measured using this tester system, values of diffused light transmittance and haze are simultaneously computed and output.

In the light diffusing silicone rubber composition, various additives may be incorporated insofar as optical properties and silicone rubber physical properties are not impaired. Suitable additives include colorants, antistatic agents, and antioxidants, which may be used alone or in combination of two or more. The colorants are used for imparting a color tone to the molded silicone rubber to improve its esthetic appearance, the antistatic agents are used for preventing electrostatic deposition of dust on the surface of the molded silicone rubber, and the antioxidants are used for preventing the resin microparticulate diffusing agent from discoloring through oxidative degradation.

Suitable colorants include organic pigments such as condensed azo, isoindolinone, quinacridone, diketopyrrolopyrrole, anthraquinone, dioxazine, copper phthalocyanine, and allyl amide; inorganic pigments such as titanium oxide, zinc oxide, iron oxide (red iron oxide, black iron oxide), ultramarine, cobalt blue, carbon, and bismuth vanadate; and dyes such as azo, chromium complexes, cobalt complexes, anthraquinone, and phthalocyanine. Of these, organic and inorganic pigments are preferred from the standpoints of dispersion in the silicone rubber composition, coloring power and color stability. Such colorants may be used alone or in combination of two or more. Since most colorants have a propensity to prevent light transmission, addition of the colorant in a large amount can reduce the overall transmittance. For this reason, the colorant may be used in an amount of 0.0001 to 0.1 part, preferably 0.001 to 0.01 part by weight relative to 100 parts by weight of the transparent or semitransparent silicone rubber compound.

Suitable antistatic agents include carbon, conductive zinc white, lithium salt-containing ion conducting agents such as lithium perchlorate and amido-lithium compounds, ionic liquids such as imidazolium salts and pyridinium salts, alcohol derivatives, glycol derivatives, glycerol derivatives, and polyether derivatives. The lithium salt-containing ion conducting agents and ionic liquids are known to exert a significant antistatic effect even in small amounts. These antistatic agents may be used alone or in combination of two or more. Since the solid antistatic agent has a propensity to prevent light transmission, a choice of a liquid antistatic agent is preferred in order to prevent any lowering of overall transmittance. The antistatic agent may be used in an amount of 0.01 to 20 parts, preferably 0.1 to 5 parts by weight relative to 100 parts by weight of the transparent or semitransparent silicone rubber compound.

Suitable antioxidants include hydroquinone, hydroquinone monomethyl ether, t-butyl hydroquinone, and hindered phenols such as 2,6-di-t-butyl-4-methylphenol (BHT) and 2,2′-methylenebis(6-t-butyl-4-methylphenol), which may be used alone or in combination of two or more. The antioxidant may be used in an amount of 0.001 to 1 part, preferably 0.01 to 0.1 part by weight relative to 100 parts by weight of the transparent or semitransparent silicone rubber compound.

Optical properties of a molded product obtained by curing of the light diffusing silicone rubber composition may be evaluated by curing the light diffusing silicone rubber composition at 120 to 165° C. for 10 minutes into a cured sheet of 2 mm thick, and analyzing the sheet by a haze meter to measure an overall light transmittance, diffused light transmittance, and haze. Attention must be paid to the surface of a cured sheet of the light diffusing silicone rubber composition. If the sheet surface is rough, irregular or diffuse reflection of light occurs, failing to measure optical properties accurately. Then the light diffusing silicone rubber composition is preferably molded in a mold having a mirror finish surface, or after sandwiching between liner sheets having a luster surface.

Suitable curing conditions are as follows. In the case of addition crosslinking, press molding or hot atmospheric vulcanization (HAV) may be performed at a temperature of 100 to 180° C. for a time of 15 to 3 minutes, preferably at 120 to 150° C. for 10 to 5 minutes. If necessary and preferably, this may be followed by secondary curing (post-curing) at 150 to 200° C. for 1 to 4 hours. In the case of organic peroxide crosslinking, press molding or HAV may be performed at a temperature of 120 to 200° C. for a time of 15 to 3 minutes, preferably at 150 to 180° C. for 10 to 5 minutes. If necessary and preferably, this may be followed by secondary curing (post-curing) at 150 to 200° C. for 1 to 4 hours.

### EXAMPLE

Examples of the invention are given below by way of illustration and not by way of limitation.

### Preparation Example 1

To 100 parts by weight of millable type silicone rubber compound KE-571-U (Shin-Etsu Chemical Co., Ltd.) was added 5.0 parts by weight of a light diffusing agent MBX-8 (Sekisui Plastics Co., Ltd.) in the form of spherical microparticulates of crosslinked polymethyl methacrylate having an average particle size of 8 μm and a refractive index of 1.49. The ingredients were kneaded for dispersion on a kneader, yielding a light diffusing silicone rubber composition precursor of milky white color.

As a reference, 0.5 and 2.0 parts by weight of addition (hydrosilylation) reaction vulcanizing agent C-25A/B (Shin-Etsu Chemical Co., Ltd.) were added to 100 parts by weight of silicone rubber compound KE-571-U, followed by milling on a two-roll mill. The silicone rubber compound was sandwiched between PET films having a luster surface and press molded at 120° C. for 10 minutes using a mold sized to form a sheet of 2 mm thick. The cured sheet of 2 mm thick thus formed was analyzed by a direct reading haze computer system HGM-2 (Suga Test Instruments Co., Ltd.) to find an overall transmittance of 87%.

As another reference, 1.0 part by weight of organic peroxide vulcanizing agent C-8B (Shin-Etsu Chemical Co., Ltd.) was added to 100 parts by weight of silicone rubber compound KE-571-U, followed by milling on a two-roll mill. The compound was similarly press molded. The cured sheet of 2 mm thick thus formed was similarly analyzed to find an overall transmittance of 85%.

### Preparation Example 2

A light diffusing silicone rubber composition precursor of milky white color was prepared as in Preparation Example 1 aside from using a light diffusing agent SBX-4 (Sekisui Plastics Co., Ltd.) in the form of spherical microparticulates of crosslinked polystyrene having an average particle size of 4 μm and a refractive index of 1.59 and changing the amount thereof to 1.0 part by weight.

### Preparation Example 3

A light diffusing silicone rubber composition precursor of pale blue color was prepared as in Preparation Example 1 aside from further blending 0.5 part by weight of a blue color master batch besides the light diffusing agent. It is noted that the blue color master batch was prepared by adding 1 part by weight of a blue pigment ultramarine #2000Z (Daiichi Chemicals Co., Ltd.) to 99 parts by weight of silicone rubber compound KE-571-U and milling for dispersion on a two-roll mill.

### Preparation Example 4

A light diffusing silicone rubber composition precursor of milky white color was prepared as in Preparation Example 1 aside from using a light diffusing agent KMP-5900 (Shin-Etsu Chemical Co., Ltd.) in the form of spherical microparticulates of silicone resin having an average particle size of 5 μm and a refractive index of 1.43 and changing the amount thereof to 10 parts by weight.

### Preparation Example 5

To 100 parts by weight of millable type transparent silicone rubber compound KE-1571-U (Shin-Etsu Chemical Co., Ltd.) was added 5.0 parts by weight of a light diffusing agent MBX-8 in the form of spherical microparticulates of crosslinked polymethyl methacrylate having an average particle size of 8 μm and a refractive index of 1.49. The ingredients were kneaded for dispersion on a kneader, yielding a light diffusing silicone rubber composition precursor of milky white color.

As a reference, 0.5 and 2.0 parts by weight of addition (hydrosilylation) reaction vulcanizing agent C-25A/B (Shin-Etsu Chemical Co., Ltd.) were added to 100 parts by weight of silicone rubber compound KE-1571-U, followed by milling on a two-roll mill. The silicone rubber compound was sandwiched between PET films having a luster surface and press molded at 120° C. for 10 minutes using a mold sized to form a sheet of 2 mm thick. The cured sheet of 2 mm thick thus formed was analyzed by a haze meter system HGM-2 (Suga Test Instruments Co., Ltd.) to find an overall transmittance of 90%.

### Preparation Example 6

To 100 parts by weight of millable type silicone rubber compound KE-951-U (Shin-Etsu Chemical Co., Ltd.) was added 5.0 parts by weight of a light diffusing agent MBX-8 in the form of spherical microparticulates of crosslinked polymethyl methacrylate having an average particle size of 8 μm and a refractive index of 1.49. The ingredients were kneaded for dispersion on a kneader, yielding a light diffusing silicone rubber composition precursor of milky white color.

As a reference, 1.0 part by weight of organic peroxide vulcanizing agent C-8B (Shin-Etsu Chemical Co., Ltd.) was added to 100 parts by weight of silicone rubber compound KE-951-U, followed by milling on a two-roll mill. The silicone rubber compound was sandwiched between PET films having a luster surface and press molded at 120° C. for 10 minutes using a mold sized to form a sheet of 2 mm thick. The cured sheet of 2 mm thick thus formed was analyzed by a haze meter system HGM-2 (Suga Test Instruments Co., Ltd.) to find an overall transmittance of 68%.

### Preparation Example 7

A light diffusing silicone rubber composition precursor of milky white color was prepared as in Preparation Example 6 aside from using a light diffusing agent SBX-4 in the form of spherical microparticulates of crosslinked polystyrene having an average particle size of 4 μm and a refractive index of 1.59 and changing the amount thereof to 1.0 part by weight.

### Preparation Example 8

To 100 and 100 parts by weight of two-part type liquid addition (hydrosilylation) curing silicone rubber KE-1950-70A/B (Shin-Etsu Chemical Co., Ltd.) were added 1.0 and 1.0 part by weight of a light diffusing agent SBX-6 (Sekisui Plastics Co., Ltd.) in the form of spherical microparticulates of crosslinked polystyrene having an average particle size of 6 μm and a refractive index of 1.59. The ingredients were combined, kneaded and vacuum deaerated on a planetary mixer, yielding a light diffusing silicone rubber composition of milky white color.

As a reference, 100 and 100 parts by weight of silicone rubber KE-1950-70A/B were mixed, vacuum deaerated, sandwiched between PET films having a luster surface and press molded at 120° C. for 10 minutes using a mold sized to form a sheet of 2 mm thick. The cured sheet of 2 mm thick thus formed was analyzed by a haze meter system HGM-2 (Suga Test Instruments Co., Ltd.) to find an overall transmittance of 89%.

### Preparation Example 9

A light diffusing silicone rubber composition of pale blue color was prepared as in Preparation Example 8 except that 1.0 and 1.0 part by weight of a light diffusing agent SBX-4 in the form of spherical microparticulates of crosslinked polystyrene having an average particle size of 4 μm and a refractive index of 1.59 were added to liquids A and B of KE-1950-70A/B, and further 0.5 and 0.5 part by weight of blue color paste were added thereto. It is noted that the blue color paste was prepared by adding 1.0 part by weight of a blue pigment ultramarine #2000Z (Daiichi Chemicals Co., Ltd.) to 99 parts by weight of dimethylsilicone oil KF-96H (Shin-Etsu Chemical Co., Ltd., 100,000 cs), kneading on a planetary mixer, and dispersing on a three-roll mill.

### Preparation Example 10

To 100 and 100 parts by weight of two-part type liquid addition (hydrosilylation) curing transparent silicone rubber KE-1935A/B (Shin-Etsu Chemical Co., Ltd.) were added 5.0 and 5.0 part by weight of a light diffusing agent MBX-8 in the form of spherical microparticulates of crosslinked polymethyl methacrylate having an average particle size of 8 μm and a refractive index of 1.49. The ingredients were combined, kneaded and vacuum deaerated on a planetary mixer, yielding a light diffusing silicone rubber composition of milky white color.

As a reference, 100 and 100 parts by weight of silicone rubber KE-1935A/B were mixed, vacuum deaerated, sandwiched between PET films having a luster surface and press molded at 120° C. for 10 minutes using a mold sized to form a sheet of 2 mm thick. The cured sheet of 2 mm thick thus formed was analyzed by a haze meter system HGM-2 (Suga Test Instruments Co., Ltd.) to find an overall transmittance of 94%.

### Examples 1 to 10 and Comparative Examples 1 to 3

Each of the light diffusing silicone rubber composition precursors of Preparation Examples 1 to 7, after blending with a vulcanizing agent as shown in Table 1 or each of the liquid silicone rubber compositions of Preparation Examples 8, 9 and 10 containing the addition curing agent as such was sandwiched between PET films having a luster surface and press molded under the conditions shown in Table 1 using a mold sized to form a sheet of 2 mm thick.

The cured sheets of 2 mm thick thus formed were analyzed by a direct reading haze computer system HGM-2 (Suga Test Instruments Co., Ltd.) to measure an overall transmittance, diffused light transmittance, and haze. The results are shown in Table 1.

TABLE 1

| | | Composition | | | | | | | | |
|---|---|---|---|---|---|---|---|---|---|---|
| | | precursor or | | | | Vulcanizing | | | | |
| | | composition | Vulcanizing agent | | | conditions | | Overall | Diffused light | |
| | | Preparation | (pbw) | | | Temp. | Time | transmittance* | transmittance* | |
| | | Example:(pbw) | C-25A | C-25B | C-8B | (° C.) | (min) | (%) | (%) | Haze value* |
| Example | 1 | 1:100 | 0.5 | 2.0 | — | 120 | 10 | 71 | 66 | 93 |
| | 2 | 1:100 | — | — | 1.0 | 165 | 10 | 68 | 63 | 93 |
| | 3 | 2:100 | 0.5 | 2.0 | — | 120 | 10 | 73 | 68 | 93 |
| | 4 | 2:100 | — | — | 1.0 | 165 | 10 | 70 | 65 | 93 |
| | 5 | 3:100 | 0.5 | 2.0 | — | 120 | 10 | 71 | 66 | 93 |
| | 6 | 3:100 | — | — | 1.0 | 165 | 10 | 68 | 63 | 93 |
| Comparative | 1 | 4:100 | 0.5 | 2.0 | — | 120 | 10 | 83 | 38 | 43 |
| Example | | | | | | | | | | |
| Example | 7 | 5:100 | 0.5 | 2.0 | — | 120 | 10 | 75 | 66 | 92 |
| Comparative | 2 | 6:100 | — | — | 1.0 | 120 | 10 | 43 | 65 | 91 |
| Example | 3 | 7:100 | — | — | 1.0 | 120 | 10 | 48 | 68 | 91 |
| Example | 8 | 8:100 | — | — | — | 120 | 10 | 75 | 66 | 93 |
| | 9 | 9:100 | — | — | — | 120 | 10 | 75 | 65 | 93 |
| | 10 | 10:100 | — | — | — | 120 | 10 | 78 | 68 | 94 |

*Measurement method/conditions An overall transmittance (%), diffused light transmittance (%), and haze were measured using a direct reading haze computer system HGM-2 (Suga Test Instruments Co., Ltd.) under conditions of C light source, visual field 2°, and light flux diameter 13 mm.

Japanese Patent Application No. 2009-219327 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A light diffusing silicone rubber composition comprising
100 parts by weight of a silicone rubber compound having an overall transmittance of at least 70% when measured in a cured sheet of 2 mm thick, and
0.01 to 10 parts by weight a light diffusing agent added and dispersed in the silicone rubber compound, said light diffusing agent being of at least one polymeric resin selected from the group consisting of poly(meth)acrylate resins, polystyrene resins, and (meth)acrylate-styrene copolymers, in microparticulate form having an average particle size of 0.3 to 100 μm.

2. The silicone rubber composition of claim 1 wherein said light diffusing agent of microparticulate resin has a refractive index of at least 1.48 with respect to sodium D line at 25° C.

3. The silicone rubber composition of claim 1 wherein said light diffusing agent is of a crosslinked polymeric resin in microparticulate form.

4. The silicone rubber composition of claim 1 wherein said light diffusing agent is in the form of spherical microparticulates.

5. The silicone rubber composition of claim 1, further comprising an addition curing agent or organic peroxide curing agent.

6. A molded light diffusing silicone rubber comprising the light diffusing silicone rubber composition of claim 1 in the cured state, said silicone rubber having an overall transmittance of at least 50%, a diffused light transmittance of at least 45%, and a haze of at least 90, when measured in a cured sheet of 2 mm thick.
